(19) United States
(12) Patent Application Publication
(10) Pub. No.: US 2001/0000300 A1
(43) Pub. Date: Apr. 19, 2001

(54) Desktop projection monitor

(76) Inventor: Endale G. Haile-mariam, Wheaton, MD (US)

Correspondence Address: Michael de Angeli, Suite 330, 1901 Research Boulevard, Rockville, MD, 20850, US

(21) Appl. No.: 09/726,041

(22) Filed: Nov. 30, 2000

Related U.S. Application Data
(63) Continuation-in-part of application No. 09/323,651, filed on Jun. 1, 1999, now abandoned.
(60) Provisional application No. 60/108,100, filed on Nov. 12, 1998.

(51) Int. Cl. G03B 21/26; G03B 21/00; G03B 21/14

(52) U.S. Cl. 353/30; 353/70

(57) ABSTRACT

A “Desktop Projector”, comprising a small projector, preferably supported by a mechanical arm, and a separate reflective screen, for use in lieu of a conventional computer monitor, provides substantial benefits in terms of reduced eyestrain. The projector in this application is basically a display engine with plastic enclosure, controls and user interface to form the finished product. The screen can be hung on a wall or from a ceiling or stand upright on an office desk, or could be the wall itself or a coating on the wall. The mechanical arm enables the user to control the distance from the screen to the projector, while providing a secure support for the projector and minimizing the need for monitor desk space. The arm can rotate a full circle either at the vertical cylinder or at the resting plate. This flexibility allows the projector to face the screen at the correct angle for various distances at any clamping position on the office desk. The invention maximizes the image size and the distance between the user and the image, reducing eyestrain, and provides a reflection in the image path between the projector and the user, further reducing eyestrain.

### CROSS-REFERENCE TO RELATED APPLICATIONS

1. This application claims an invention which was disclosed in Provisional Application No. 60/108,100, filed Nov. 12, 1998, entitled “Desktop Projector”. The benefit under 35 USC §119(e) of the United States provisional application is hereby claimed, and the aforementioned application is hereby incorporated herein by reference. This application is also a continuation-in-part of Ser. No. 09/323,651, filed Jun. 1, 1999.

### FIELD OF THE INVENTION

2. The invention pertains to the field of display devices. More particularly, the invention pertains to video displays for computers using projection technology, and to reduction in eyestrain made possible thereby under certain circumstances.

### BACKGROUND OF THE INVENTION

3. Dr. Steven Sauter has studied extensively the health effects of Video Display Terminals (“VDTs”, also referred to as “cathode-ray tubes” or “CRTs”, and generally as computer monitors) and describes the common problem of eyestrain occassioned by their extensive use:

4. As a class, visual system disturbances such as sore, aching, irritated, or tired eyes, and blurred or double vision are probably the most common health-related complaints among VDT users. Headache is often included in this cluster. Together, these types of disturbances are often referred to loosely as asthenopia, visual fatigue, or simply eyestrain . . . “Occupational Health Aspects of Work With Video Display Terminals”, from Environmental and Occupational Medicine. pp 1109-1119, William N. Rom, ed., Boston: Little, Brown, 1992, ISBN 0316755672.

5. A Cathode Ray Tube creates images by shooting an electron gun at a wall of phosphor elements aligned in a grid. When hit by electrons, these elements emit photons directly at the user. There is a direct transmission of light from the phosphor elements, where the light is generated, to the user. “Direct transmission” is defined as light travelling in a path without reflection. From the 2-dimensional phosphor grid, the photons collectively produce an image as the gun sweeps from left to right and top to bottom in a process called raster scanning. The screen is usually redrawn, or refreshed, 60 or more times in a second. A fundamental aspect of the CRT technology is the direct transmission of the image over a short distance, the principal cause of eyestrain and headaches.

6. A 1991 poll of office workers by the Louis Harris Organization (Journal of Behavioral Optometry, Vol. 5, No. 3 (1994), p. 59) reported that computer eyestrain was the number one job-related complaint in the work force of the United States. The Computer Eyestrain Theory, developed by the present inventor, postulates that directly transmitted light adversely affects the human visual system. According to the theory, the solution is in using reflected light, rather than transmitted light, to alleviate computer eyestrain, assuming all other environmental and physical factors are held constant. However, it is to be understood that the invention disclosed and claimed herein is not to be limited by this theory.

7. The Computer Eyestrain Theory relies on two principles: length of the distance from the (multi-point) light source used to create the image to the viewer; and occurrence of at least one reflection in the path of the image. Both the reflection and distance contribute to creating a more random and uniform distribution of light before reaching the human visual system. More particularly, according to the theory, eyestrain occasioned by extensive work at a conventional computer monitor can be alleviated if the image is projected onto a suitable screen and there reflected towards the user's eyes, rather than being directly transmitted thereto, as in use of a conventional monitor.

8. Several point sources in close proximity can serve as a first order model for all monitors, where each pixel acts as a point source. In the natural world of the human visual system, light that is absorbed has a definite random and uniform property partly due to diffuse reflection. Human beings typically don't look straight at the Sun but rather view objects using the Sun's reflection. The light has traveled a long distance and has experienced reflection before reaching a human visual system. The human visual system is optimized to handle this type of light with a strong element of randomness. A direct transmission monitor emits light with little randomness because the distance from the monitor to the viewer is small with no reflection in the path.

9. According to the theory, the human visual system has a much harder time coping with directly transmitted light, especially for extended periods of time. Those with impaired visual systems are the ones most likely to experience more eyestrain, and it is likely to arise in a shorter time span.

10. The Computer Eyestrain Theory postulates that the most important factor in alleviating computer eyestrain is the difference between transmitted versus reflected light, assuming that the viewer is at a fixed distance close to the image source. It appears that the type of light emitted is not the root cause of eyestrain as commonly experienced; various source of light such as metal halide lamps, light-emitting phosphor pixel elements or other types can all cause computer eyestrain. Moreover, it appears that the character of the reflecting surface is not related to the alleviation of eyestrain thus provided; that is, specularly-reflecting surfaces such as aluminum or glass mirrors are equally effective in alleviation of computer eyestrain as are diffusely-reflective surfaces, such as conventional projection screens (though of course allowance must be made for the fact that a specularly-reflecting surface inverts the image, unlike a diffusely-reflecting surface).

11. Furthermore, it appears that the type of projection technology employed is not a direct factor in alleviation of computer eyestrain. Experiments have been conducted on various projection technologies from LCD (Liquid Crystal Display) and DMD™ (Digital Micromirror Devices™) to film projectors, all tending to the conclusion that a projection system alleviates eyestrain compared to all direct transmission technologies, examples of which include CRT (Cathode Ray Tube) monitors, LCD monitors, PDP (Plasma Display Panel) monitors, PALCD (Plasma Addressed Liquid Crystal Display) monitors, and FED (Field Emissive Display) monitors. The theory posits only one requirement for successfully alleviation of eyestrain otherwise occasioned by viewing a computer display image at a relatively close fixed distance, namely that the image has to be reflected before reaching the viewer.

12. Thus, according to the theory, direct transmission of the image from a conventional CRT monitor to the viewer causes most of the eyestrain. There may be other contributing factors such as the lighting at the location of the monitor, radiation, and the level of stress attributed to the work. However, keeping other environmental and physical factors constant, at a typical level, according to the theory, the principal cause of eyestrain is reflected versus transmitted light. In particular, one experiment was conducted with a CRT Monitor, as the source of the image, using two mirrors to get the correct inversion. There was eyestrain without the mirrors and no eyestrain with the mirrors, supporting the Computer Eyestrain Theory.

13. However, as noted above, the invention is not to be limited by the above theory. More specifically, and as further discussed below, provision of the image from a computer as typically provided on a CRT using reflective systems according to the invention has other benefits, in particular, that the user can be provided a larger image within a smaller physical environment.

14. An eye doctor, Dr. Cosmo Salibello, made public studies that reinforce the Computer Eyestrain Theory by experimenting with different ways to understand the behavior of the visual system. Dr. Salibello invented the concept of PRIO examination on the premise that the principal cause of eyestrain is due to the inherent mechanism by which computer monitors display information—the fact that characters created by CRT's and the like tend to appear to the eye to be closer than they actually are, resulting in the eye cycling back and forth from a “resting point of accommodation” (RPA) (the point at which the eye focuses naturally) to the apparent focus point of the screen. The so-called “PRIO glasses” now available are prescription eyeglasses which cause the RPA to coincide with the surface of the CRT. The PRIO method is set forth in Salibello et al U.S. Pat. No. 4,998,820, “Instrument and Method for use in Optometric Examinations.” The importance of the PRIO method is that it firmly establishes with the Computer Eyestrain Theory that eyestrain is not principally generated by radiation, office lighting or other factors but rather by inherent mechanism of direct transmission computer displays.

15. According to the PRIO line of thinking, it is the low frequency content of the pixels of the image, resulting in poorer contrast and lack of sharpness that cause eyestrain. This does not explain the present inventor's observation that individuals experience little or no eyestrain using a projector at a lower resolution, but experience eyestrain while using a higher resolution CRT monitor. Dr. Salibello made the contribution of describing the behavior of our visual system under computer stress. However, instead of developing a solution that addresses the inherent mechanism of most computer displays—the root cause of the problem—Dr. Salibello developed a less desirable solution, namely eyeglasses having a prescription optimized for viewing a computer monitor. Certain undesirable aspects of this approach to the computer eyestrain problem are discussed below.

16. Besides Dr. Salibello's, four other patents have features that support the Computer Eyestrain Theory, although their inventors did not recognize the fact. The following inventions use at least one mirror to reflect the optical path of a conventional CRT image in an eyestrain-reducing system: Tichenor, “Easy Viewing Device with Shielding”, U.S. Pat. No. 4,930,884, Payner, “Vision Saver for Computer Monitor”, U.S. Pat. No. 5,200,859, Katz, “Computer Terminal Operators Protection Device”, U.S. Pat. No. 5,136,434, and Jolly, “Cathode Ray Tube Screen Viewing Aid”, U.S. Pat. No. 4,605,291. In each of these cases, the inventor did not attempt to explore projection systems as an eyestrain-reducing system. Each inventor believed that eyestrain was primarily caused by one or more of the following factors: radiation; glare; eyes looking straight ahead at a near distance; eyes looking above the horizontal monitor; or the amount of eye convergence required between looking at the monitor and the keyboard. However, according to the Computer Eyestrain Theory, the common denominator across all these eyestrain reducing systems is the principle of directly transmitted light versus reflected light.

17. The Computer Eyestrain Theory also explains the fact that most people do not experience eyestrain watching TV, a CRT display technology. Most people watch TV from a distance that is much further away than the distance of most computer users from their monitor. People in the majority do not watch TV for 8 to 10 hours a day. Typically computer users experience eyestrain after working ½to 3 hours. The level of stress attributed to watching TV versus working on a computer is very different. The level of stress and duration of work pushes the visual system closer to the threshold of exhibiting symptoms of eyestrain. The additional strain of using a direct transmission display causes 50 percent of computer users worldwide to experience eyestrain, according to the National Institute of Occupational Safety and Health (NIOSH). Rom, ed.., op. cit.

18. Referring to other types of computer monitor which also cause eyestrain, an LCD monitor's principal components are a uniform backplane light source and an active matrix liquid crystal panel. Polarized light emitted from the backplane of the LCD travels through multiple layers of the liquid crystal panel. Depending on the polarization of the liquid crystal material, the traveling light will either pass (on) or not pass (off) the panel. An active matrix divides the liquid crystal material into cells. A thin film transistor (TFT) independently determines the voltage applied to each cell, and this voltage determines the state of polarization and hence whether light is transmitted through the cell. Therefore, each cell in the matrix has to change polarization state fast enough to produce an image at a rate of 60 Hz. A fundamental aspect of the LCD technology is the direct transmission of the image from the light source through the liquid crystal material to the user, the principal cause of eyestrain and headaches.

19. Three emerging display technologies, referred to as Plasma Display Panel (PDP), Plasma Addressed Liquid Crystal Displays (PALCD), and Field Emission Displays (FED) are not currently available on the market for the desktop monitor application but could be a future alternative to CRT's. All three technologies are direct transmission systems, and therefore it is anticipated that users of each will exhibit the same health issues, such as headaches and eyestrain.

20. Image size and resolution are the main parameters of interest in the computer monitor market; that is, consumers attach value to larger image sizes and higher-resolution displays. By comparison, in the TV market, where resolution is fixed by the existing television signal format, it is image size and not resolution to which consumers attach real value. Consequently, big screen televisions can command a higher price because they provide a large image size. Both smaller CRT televisions measuring up to roughly 36 inches diagonal and big screen projection televisions measuring 32 inches and above are capable of display resolutions above 600 lines, but the signal does not provide this degree of resolution. For example, conventional analog broadcasts only offer 240 lines of resolution measured in horizontal lines, while digital satellite systems offer up to 480 lines. Therefore, the consumer mindset in the TV market is that image size primarily differentiates value. Similarly, in the monitor market, the 13″monitors of several years ago have given way to 17″monitors as a standard size, and larger monitors are available. A monitor display technology that could best leverage the projection technology to produce cost effective large images would have an advantage.

21. One of the most significant characteristics of a CRT monitor is that the diagonal width of the screen is proportional to the monitor depth, making CRT monitors relatively large and heavy. The cause is attributed to the difficulty of directing the electron beam generated by the gun precisely at each phosphor element as the screen gets larger. The solution is to move the gun physically further away from the screen increasing the depth of the monitor, as well as the size of the heavy tube. Popular monitor sizes (measured diagonally) with respective weights are 15 inch weighing 31 lbs, 17 inch weighing 41 lbs, 19 inch weighing 55 lbs, 21 inch weighing 68 lbs, and 24 inch weighing 90 lbs. More particularly, such computer monitors are roughly cubical in overall shape; that is, a monitor having a screen measuring 15 inches diagonally will have comparable measurements for its width, height and depth. The depth in particular becomes a problem in the typical small cubicles provided as workspaces for many workers; while eyestrain might be reduced simply by providing a larger monitor, there simply is insufficient space for one, especially noting that the worker needs to move further away from a larger screen in order to comfortably view its entirety without excessive shifting of the user's eyes and motion of the user's head.

22. In addition, as the CRT's screen diagonal measurement increases, the monitor occupies considerably more office desk space. This is a significant factor, as desk space is nearly always at a premium.

23. As noted, resolution, e.g., as measured in pixels, is a stronger factor in the monitor market than the TV market, introducing another dimension to the value proposition. Stated differently, the difference is that the bottleneck in the TV industry is the information provided and not viewed, while the opposite is true for the monitor industry. This is the reason that we have to scroll our Microsoft Word window to view the typical document. Few people would argue that image size is clearly the first determinant of the value proposition before resolution, for good reasons. As noted, the CRT television technology has been around for decades, ingraining the mindset that bigger is better. Secondly, it doesn't make sense to introduce a new monitor with more resolution but a smaller or equal image size for a desktop monitor application. The consumer doesn't want to squeeze his or her eyes to see the fine details. The available technology can display different resolutions for a defined image size. In effect, the smaller resolution appears as a “zoom in” of the higher resolution. There are no current or emerging personal monitor technologies that can effectively change the image size measured in terms of the diagonal length of the screen.

24. Finally, there are a few products available to help people with eyestrain occasioned by viewing computer monitors. This is a small market in dollar value but growing especially in customer base with far reaching implications. It has been recognized in the market that there is money to be made selling effective solutions for computer eyestrain. Different companies have attempted to introduce different solutions to the market in the shape of antiglare filter screens, air oxidizers, and computer glasses.

25. More particularly, several companies are marketing computer filter screens as a solution to computer users experiencing eyestrain. Situated between the monitor screen and the viewer, these filter screens effectively prevent glare and reflections. To a certain degree, they improve clarity and contrast, sharpen character resolution and reduce radiation. The real question is whether screen filters provide an effective solution towards headaches and eyestrain? It is generally accepted that glare and reflection contribute to eyestrain. The extent of that contribution is debatable. However, the present inventor, having experimented with filter screens extensively from one hour to eight hours at a time, has found them in general of comparatively little help dealing with computer health issues, and in particular has found them of little or no use in alleviating eyestrain occasioned by long hours working at a direct transmission CRT. By comparison, the inventor has found eyestrain significantly reduced when practicing the method of the invention as discussed below.

26. Datavision and Devices, Image One, GlareGuard and Magnotech are all companies that market filter screens as a solution to headaches and eyestrain. In addition some of these companies also market their monitor filters as anti-radiation screens attempting to make a connection with monitor radiation and eyestrain.

27. PRIO Corporation, of Lake Oswego, Oreg. (formerly Applied Vision Concepts) has the best solution available on the current market for computer monitor eyestrain. As discussed above, PRIO's solution is based on eyeglasses having prescriptions optimized for viewing computer monitors. PRIO sells eye examination equipment to eye doctors designed to simulate computer use. Based on the PRIO examination, the eye doctor can prescribe computer glasses, that is, eyeglasses comprising conventional lenses and frames but implementing a prescription optimized for viewing a CRT. The disadvantages of PRIO glasses are several. As the PRIO glasses are only useful for viewing the screen, each time the user looks away from their computer he or she must remove or change glasses. Individuals that wear prescription contacts have to wear the PRIO computer glasses over their contacts each time they are in front of a computer, defeating the purpose of having contacts. Despite these shortcomings, PRIO has experienced reasonable commercial success, demonstrating some valaidity to their concept and understanding of the computer eyestrain problem.

28. As noted above, computer monitors take up a large amount of valuable desk space. Recognizing this, there are a large number of patents for monitor support mechanisms, for example U.S. Pat. No. 4,844,387, “Monitor arm apparatus”. None of these patents suggest using the arms to support a projector in a desktop application; the relevance of this observation will be made apparent below.

29. There are video projectors currently on the market which can accept computer VGA, SVGA or XGA input, which are designed for projecting relatively large images for groups of people. Such projectors are available from Sony, In-Focus Systems, Polaroid, and others, and in recent years have become almost universal for “slide talk” presentations using software such as Microsoft's PowerPoint, essentially replacing the older overhead projector and foils with an electronic equivalent. Video projectors have not, however, been used in a single-viewer desktop application, without complicated fixed arrangements of beam-splitters, mirrors, and so on.

30. McNelley and Machtig U.S. Pat. No. 5,639,151 for “Pass-Through Reflective Display” recognizes the problems inherent in the use of CRTs, including eyestrain caused by CRT use, and the bulkiness of larger displays and the requirement of longer viewing distances needed to use larger displays. This patent discloses a desktop monitor system using a fixed position projector projecting a video image onto a horizontal screen. An angled beam-splitter reflects the image toward the viewer. This is done to allow a camera to be placed directly behind the beamsplitter in line with the viewer, so that when the display is used for video teleconferencing, the viewer can appear to maintain eye contact with the image of the sender on the screen. The image size is not adjustable, and the mirrors and projector housing take up significant amounts of desktop.

31. Fergason U.S. Pat. No. 5,629,806 for “Retro-reflector Based Private Viewing System” uses a similar arrangement of beamsplitter and screen, plus another screen and mirror, to limit the viewing angle of the resulting display for privacy purposes.

32. Gale et al U.S. Pat. No. 5,692,820 for “Projection Monitor” discloses a large-screen monitor comprising a lamp, light from which is modulated to produce an image that is projected onto a rear-projection screen. The light emitted from the lamp is reflected at least once by a mirror inside the device before reaching the screen. The inventors describe the advantages of this display primarily in terms of the technological advantages of producing a larger computer screen in a smaller package, e.g., suitable for desktop use. Eyestrain reduction per se does not appear to be an object of this invention. Although the inventors did not recognize the desirability of reflection, the Gale device does conform to this aspect of the present inventor's Computer Eyestrain Theory. The image size is not adjustable, and the unit would take up significant desk space if it were used as such. Projectors have been used in a number of vehicle systems to provide electronic dashboards or “head up display” systems. Typical of this application is lino, U.S. Pat. No. 4,967,191, “Display Apparatus for Automotive Vehicle”. In these applications, the intention is not a desktop display for a computer, the image size is not adjustable, and the arrangement of parts is specific to the vehicular application, which is not analogous to the desktop display environment.

### SUMMARY OF THE INVENTION

33. According to the invention, a new computer display system is provided, termed a “Desktop Projector”. The system comprises a small projector, preferably supported by a mechanical support arm mechanism fixed to the desk surface, e.g., by being clamped to a desk edge, to further reduce desk space requirements and provide adjustability, and a separate reflective screen. The projector in this application is basically a display engine with plastic enclosure, controls and user interface to form the finished product. The screen can be hung on a wall, from a ceiling, or stand upright on an office desk or floor, or could be the wall itself or a coating on the wall.

34. Provision of the mechanical arm enables the user conveniently to adjust the distance from the screen to the projector, while providing a secure support for the projector and minimizing the need for monitor desk space. Furthermore, supporting the projector on arm allows the projector to be spaced further from the screen than permitted by the depth of the desk, which can be important in providing sufficient spacing to allow focusing. The arm can preferably rotate a full circle either at the vertical cylinder or at the resting plate. This flexibility allows the projector to face the screen at the correct angle for various distances at any clamping position on the office desk. The advantage of providing variable distance functionality is greater choice of image sizes. The actual image size provided by this monitor depends on the focal length of the lens and the distance to the screen, from as little as 10 inches (measured diagonally) to 30 to 50 inches, depending on the space available.

35. The Desktop Projector embodies the principles of the Computer Eyestrain Theory, featuring inherent design advantages over all current and emerging personal monitors in the display industry, including provision of user-defined variable image size, and much longer total product lifetime with user-replaceable lamps. In addition, the desktop projector of the invention is superior to the overwhelmingly established CRT monitor because of its minimal desktop usage and light weight.

36. More particularly, provision of the Desktop Projector according to the invention allows a relatively large image to be provided to the user in a relatively small space. For example, the projector can be located other than directly in front of the user, as is necessary in use of a CRT, and the screen can be spaced some distance away. In a typical direct replacement of a CRT by the projector and screen according to the invention, the overall distance between the projector and the user's eye is at least double than that between the CRT and the user. Because the screen is essentially flat, the distance between the user and the screen is greater than the distance between the user and the CRT by at least the depth of the CRT. Thus increasing the spacing between the user and the screen itself substantially reduces eyestrain, since the user is focussing on a larger image at a greater distance. Reflection of the image is also provided, which is further beneficial as postulated by the inventor's Computer Eyestrain Theory.

### BRIEF DESCRIPTION OF THE DRAWING

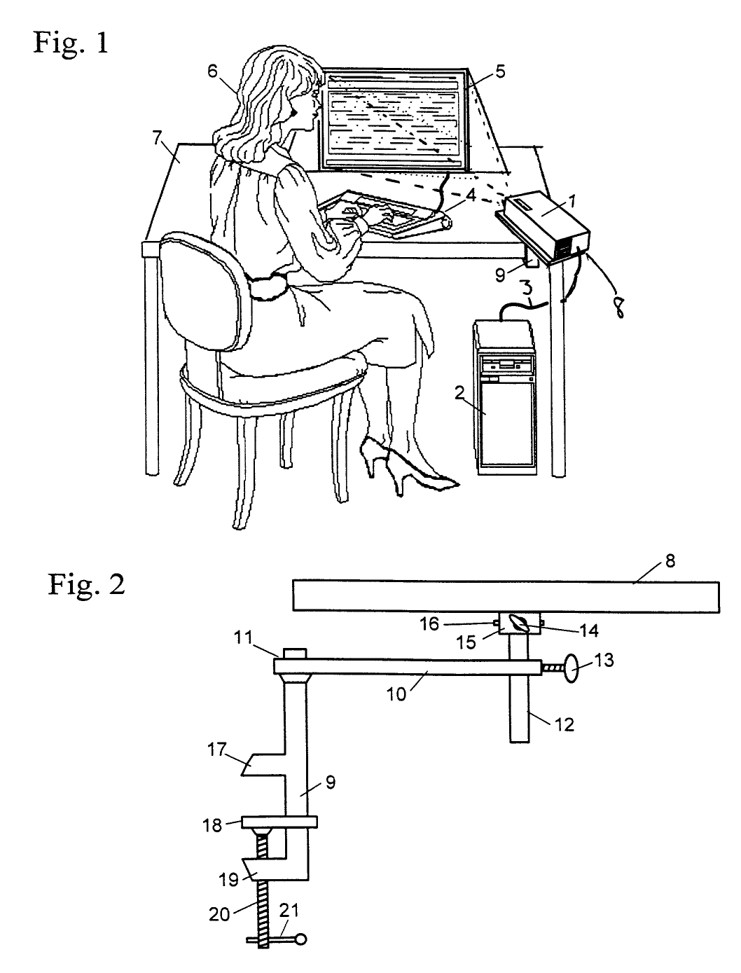

37. FIG. 1 is a perspective view showing the desktop projector system of the invention in use, in an embodiment having a table-top supported screen and the projector support of FIG. 2;

38. FIG. 2 shows a view of a projector support for use with the invention;

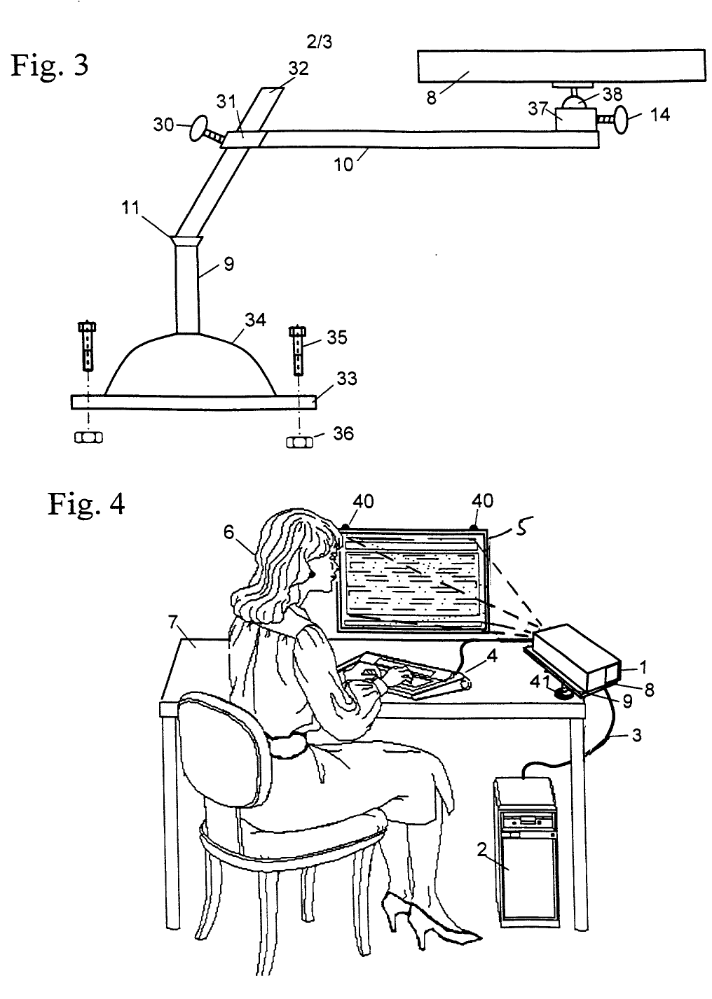

39. FIG. 3 shows another embodiment of a projector support for use with the invention;

40. FIG. 4 is a view comparable to FIG. 1, but showing the desktop projector monitor of the invention in use, in an embodiment having a screen hung on a wall, and the projector support of FIG. 6;

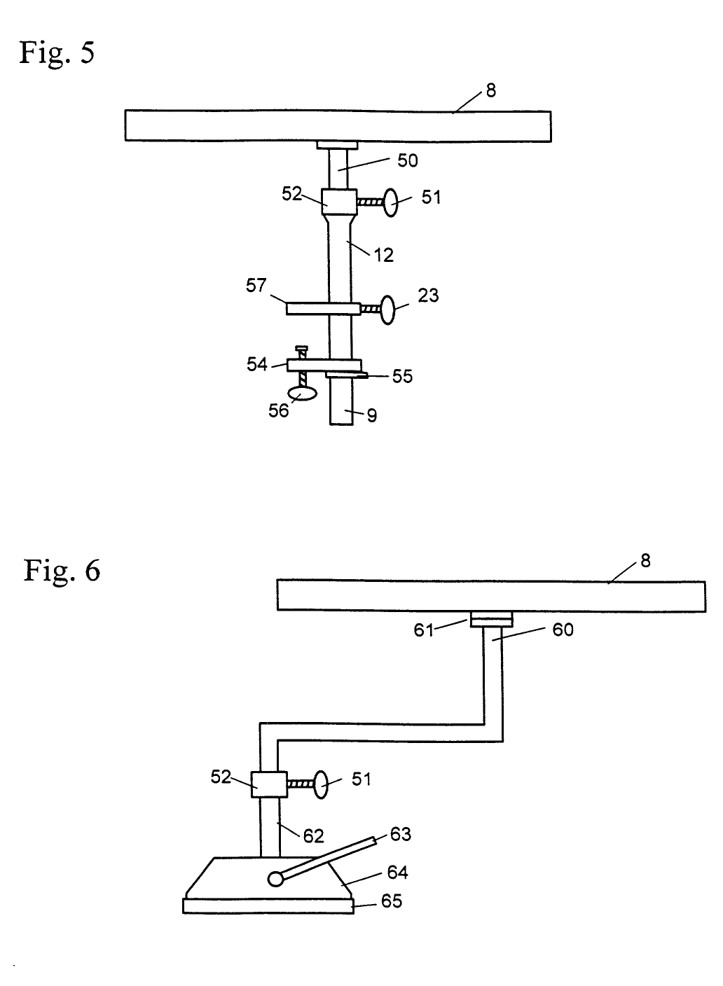

41. FIG. 5 shows another embodiment of a projector support for use with the invention;

42. FIG. 6 shows another embodiment of a projector support for use with the invention;

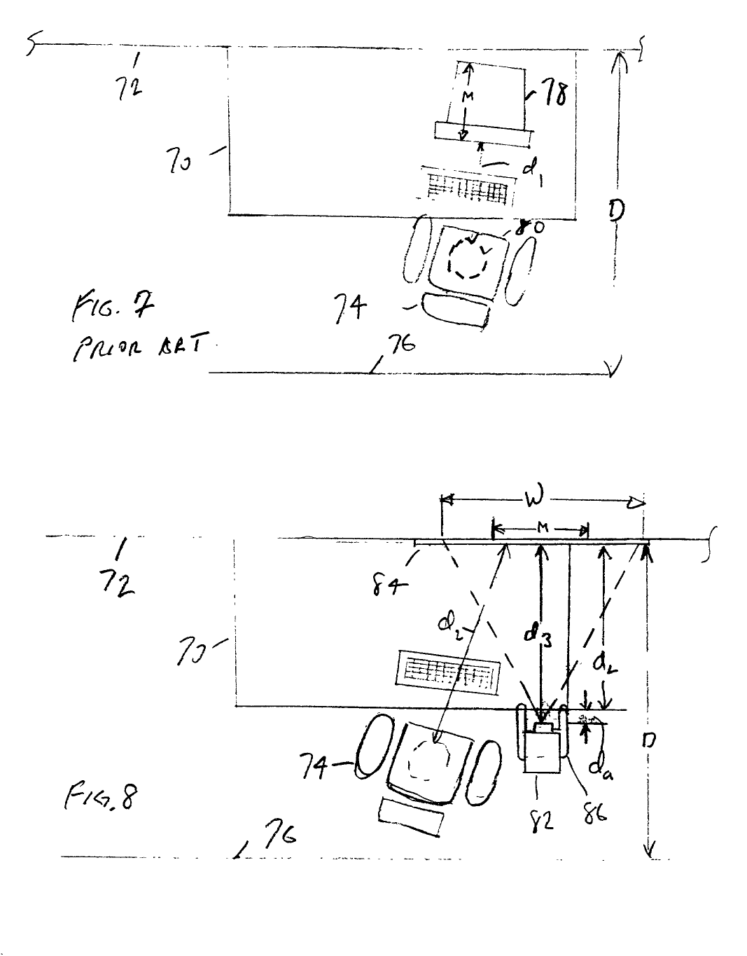

43. FIG. 7 is a schematic plan view showing a typical workspace using existing CRT monitor; and

44. FIG. 8 is a view comparable to FIG. 7, showing the same workspace but using the display projector system of the invention, and thus illustrating the advantages provided by the invention.

### DESCRIPTION OF THE PREFERRED EMBODIMENTS

### Overall Description

45. Referring to FIG. 1, the desktop projector of the invention can be broken into three principal parts: the projector (1); the adjustable projector support structure, having a table attachment (9), with an adjustable support arm (10) for a projector tray (8), and a screen (5). The individual parts of the desktop projector system will be discussed in greater detail below.

46. In the embodiment shown, the projector support structure is attached to a computer user's desk (7) by a clamp (9) or other attachment means such as a screwed-down mounting plate (for a permanent installation), or the like. The projector tray (8) supports the projector (1) off the desktop (7), to give the maximum desk space for the user (6). The projector tray may be moved on the adjustable support structure over a wide range of positions and angles. The projector (1) is connected to the user's computer (2) by conventional cables (3). The user places her keyboard (4) on the desktop or on a keyboard tray, as is conventional. The screen (5) is located near the back of the desk (7), to allow maximum distance from the projector (1), and may, in fact, be hung on the rear wall of a cubicle or office. If suitably smooth and light-colored, the wall itself may be used as the screen, which is the ultimate “flat display”.

47. FIG. 4 shows such an arrangement, with the flat screen (5) being hung from the wall by hangers (40). FIG. 4 also shows a variation on the mounting of the projector support, in which the projector support tray (8) is mounted to the desktop with a vacuum base (41), which allows easy mounting and removal, and simple adjustment of the projector position across the desktop.

48. Thus, using the system as shown in FIG. 1, the user views her computer's display as light reflected from a screen, rather than by direct transmission as is the case with monitors of the CRT, LCD, plasma and other types. By the Eyestrain Theory set forth above, this dramatically reduces the eyestrain involved in using the display over the direct transmission systems.

49. According to the invention, the viewed image is produced using a projection system. The display size can be varied easily and over a wide range of sizes by moving the projector toward or away from the screen, and by the built-in zoom lens of the projector, if it is so equipped, while the actual image as provided by the computer does not change.

50. If the screen is large, or the wall itself is used, the position of the display may also be easily changed by swiveling the projector on its adjustable support structure. The display brightness and focus are also adjustable using the projector's controls.

### The Projector

51. The desktop projector of the invention does not require any specific projector type. Various suitable projectors are readily available, and are quickly evolving in price and quality as the technology improves. The three-CRT projectors of a decade ago have been supplanted by LCD-based projectors capable of much higher resolution with a much smaller footprint and no complicated and time-consuming convergence procedures. The 640 by 480 pixel resolution VGA projectors of just two years ago are far surpassed by today's 800 by 600 pixel SVGA projectors which cost less than half as much. Any of these technologies, or others which might be developed in the future, would be appropriate for use with the invention.

52. For example, the InFocus LP225, manufactured by InFocus Systems, inc. of Wilsonville, Oreg., is a true 800×600 (SVGA) resolution projector capable of 16.7 million colors. With compression, the LP225 can handle 1024×768 (XGA) images.

53. A complete projector basically consists of an imaging system with associated drive circuitry, a complementary optical lens system, and a light source. In recent years, each component technology has made real progress to make the projection technology a viable alternative for personal displays. The lens technology has not changed dramatically in terms of affecting engine performance as compared to the other components, but automatic zoom and power focus lenses are becoming more common than the fixed focal length, manual-focus lenses of the recent past.

54. With today's computer standards, a projector for use with the desktop projector monitor of the invention will have the capability of projecting at least standard VGA resolution (640 by 480 pixels), and preferably SVGA or XVGA resolution of 800 by 600 pixels or greater. It can be expected that as time goes on even higher resolutions will become standard. Additional input formats, such as NTSC/PAL video, would be advantageous if other video sources such as videotape were to be used.

55. A zoom lens is preferred, but not essential, to allow the size of the image to be easily changed without physically moving the projector. If a fixed-focal-length lens is used, it should be of such a focal length as to be able to display a screen image of reasonable size (e.g., 19″-24″diagonal) at a projector to screen distance of not much more than the depth of an average desk (two to three feet).

56. Also preferred in a projector is an adjustment for horizontal and vertical “keystoning”, or distortion of the display caused by the projector not being exactly aligned with the screen. Obviously, it would be awkward to move the projector on its support arm directly in front of the user. With keystoning adjustment, the projector can be off to one side, and above or below the screen, as shown in FIG. 1, and the display will be undistorted. This can be done either by distorting the image on the LCD or CRT internal to the projector, or by physically angling the LCD or CRT. Keystoning adjustments are available on many, if not most, of the projectors currently available.

57. An additional inherent functionality of the Desktop Projector is the ability for the customer to easily remove the projector from the mechanical arm for independent use as a presentation tool in front of a small audience.

58. Preferably, the projector chosen for the desktop projector of the invention will have a user replaceable lamp. This provides a relatively inexpensive solution in prolonging the life of a projection system beyond any other emerging display technology. A user replaceable lamp will speed turnaround in getting a bright projector running again. Turnaround is faster with a user replaceable lamp because time is not wasted shipping the projector to the shop, and the processing time of the shop is no longer a factor.

59. A projection system is brighter than a non-projection display system but the real question is how much brighter? In this application, brightness can be defined as the amount of light that reaches a given viewing area or screen. After experimenting with a p-Si LCD projector with a 200 ANSI lumen capacity and comparing it with CRT technology, we have confidence that a state of the art projection system, producing an image 14 to 19 times brighter than the experimental projector, such projectors being expected to be commercially available in the near future, will be brighter than CRT monitor technology.

### The Screen

60. The screen used for the desktop projector of the invention can be of any convenient design and size consistent with the provision of a display of chosen size. As typical projectors produce noninverted images, conventional diffuse screens (i.e., as opposed to specular mirrored surfaces, which invert the image) are preferred. Preferably, the screen will be at least as large as a conventional monitor—17″ or more on the diagonal, with the standard width-to-height aspect ratio of approximately 1.3:1. A rigid screen is preferred to the roll-up kind commonly used for slide projection, so that the display will be as consistent as possible.

61. As shown in FIG. 1, the screen (5) may be supported by side wings (22), or a rear support structure, or may be clamped to the rear edge of the desk. Alternatively, the screen can be a conventional slide-projector type screen standing on the floor behind the desk, or, as shown in FIG. 4, a rigid flat screen hung from the wall or ceiling by any conventional means, such as hooks (40). The surface of the screen can be any of the conventional screen surfaces, such as lenticular or beaded, or could be simply smooth white flat or semi-gloss material.

62. If the rear wall of the office or cubicle is flat and smooth enough (plaster or plasterboard, as opposed to rough sound-deadening cloth), then the wall itself may be used as a screen. A part of the wall can be painted white, or coated with a high-reflectance white coating such as is used on conventional projection screens.

### The Adjustable Projector Support

63. Preferably, the desktop projection monitor of the invention has an adjustable projector support structure made up of a desk- or table-top mount, a projector tray, and a support arm for movably and adjustably supporting the projector tray. The goal in preferring the use of a support arm, as opposed to simply resting the projector on the desktop, is that this allows the projector to be spaced further from the screen than permitted by the desktop itself, thus enabling a functional display system in a very confined space. Furthermore, supporting the projector on a support arm allows for ready adjustment of the position of the projector with respect to the screen, and consumes the minimum amount of desktop space. The adjustable projector support should permit the projector to be supported above the desktop, and should be removable from the table top and capable of attachment at variable predetermined locations on the desk. Provision of height adjustment of the projector support and of the ability of the projector tray to swivel is also preferred but not required. Preferably, there would also be an adjustment for the tray angle with respect to the horizontal, although this can be omitted if the projector has an adjustable front foot, as most do.

64. Commercially available adjustable monitor supports, such as the model P6143 “Deskit” made by AVF Group, Ltd., of Telford, Shropshire, UK, could be used with the invention, with the monitor support surface serving as the projector support tray. The Sorgi patent, 4,844,387, cited above, shows such a monitor support.

65. FIGS. 2, 3, 5 and 6 show a number of embodiments of an adjustable projector support structure which can be used with the desktop projector of the invention. The various features of the supports shown in these figures can also be interchanged among the embodiments, as will be recognized by one skilled in the art.

66. Referring to FIG. 2, in this embodiment the support structure has a lower portion (9) for attaching the support to the user's desk or table. The lower portion can provide other means of attachment as well, in place of the clamp, such as a flat plate to be permanently fastened to the table top, strong suction mounts, or other arrangements as are known to the art. In this clamp embodiment, the bottom end (19) of the lower portion extends at right angles to the vertical portion, and is drilled and tapped to accept a screw (20). The screw (20) pushes on a sliding bar (18), clamping the table top between the bar (18) and a horizontal bar (17) on the support lower structure (9). The bar (18) provides more clamping area for a stronger hold and less chance of marring the underside of the table top. If desired, however, the bar (18) could be omitted, and the screw (20) could be provided with a domed swivel end as is commonly used for C-clamps or the like. Preferably, the screw (20) is fitted with a t-bar (21) or other handle, for ease of tightening and loosening. Alternatively, the end of the screw could have a wing or hex-nut shape, or there could be more than one screw.

67. At the upper end (11) of the lower portion (9) a lip or collar supports the swivel arm (10), which has a hole which fits over the end of the lower portion (9), allowing the swivel arm (10) to swivel around the lower portion (9). At the other end of the swivel arm (10), in this embodiment, another hole fits a shaft (12) extending downward from the projector tray (8). A set-screw (13), fitting in a tapped hole in the end of the swivel arm (10), can be screwed against the shaft (12), holding it in place. The tray (8) can be adjusted to a wide range of projector heights by sliding the shaft (12) in the hole and tightening the set-screw (13). As noted, preferably the shaft (12) is attached to the projector tray (8) through a mechanism which permitting tilt adjustment of the tray (8). In the embodiment shown, the end of the shaft (12) is attached by a pin (16) to a U-shaped bracket (14). When the set-screw (14) is loosened, the tray (8) may be tilted on the pin (16) to the desired tilt angle, and then held at that angle by tightening the set-screw (14). Alternatively, the projector tray could be supported on a conventional ball-joint or double-swivel, or other such arrangement conventionally used on tripod heads or the like, providing an additional degree of adjustment.

68. FIG. 3 shows an alternate embodiment of the support of FIG. 2, in which an extension (32) of the lower portion (9) is at an angle to the vertical. The inner end (31) of the swivel arm (10) is formed as a collar, with a set-screw (30), so that it may be moved along the extension (32) to adjust the height and position of the arm (10). The extension (32) may be fixed in position, or, by being formed of a smaller diameter material and fit into the upper end (11) of the lower portion (9), may swivel around to provide more flexibility to the positioning of the projector tray. In the FIG. 3 embodiment, the projector tray (8) is supported on a ball-joint having a body (37) attached to the swivel arm (10), and a ball (38) within the body, to which the tray (8) is attached by a short post. A set-screw (14) holds the ball (38) in position, but when the set-screw (14) is loosened, the projector tray (8) may be tilted in any direction. FIG. 3 also shows an alternative to the clamp base of FIG. 2, in which the lower portion (9) of the support is bolted to the work surface using a fixed base (34) into which the lower portion (9) fits. Base (34) has a flange (33) with holes through which bolts (35) may be fit. The work surface is drilled for the bolts (35), and the bolts (35) are fastened down with matching nuts (36). Alternatively, wood screws or self-tapping sheet metal screws, or lagbolts, could be used in place of the bolt-and-nut arrangement.

69. FIG. 5 shows a simple projector support arrangement, in which the projector tray (8) is fixed to a vertical support strut (50). The lower section of the support (9) is clamped to the table edge by a two-part clamp having an upper part (57), which may be slid along the length of the lower section (9) and fixed in place by a set-screw (23), and a lower part (54) which can also be slid along the length of the lower section (9) by depressing a slide clamp lever (55). When the lower part of the clamp has been adjusted close to the bottom of the tabletop, the clamp lever (55) is released, and the clamp screw (56) is tightened to hold the support firmly to the table top. The height of the tray (8) may be varied by sliding strut (50) into the hollow upper section of the support base (12), and locking it in place with a set-screw (51) threaded into a collar (52), tripod leg clamp, or similar element.

70. FIG. 6 shows another embodiment of the projector support. In this embodiment, the support arm (60) for the tray (8) is bent at right angles, so as to provide a single-piece support and horizontal movement arm. The height of the support arm (60) can be adjusted as described in FIG. 5, above, by sliding the lower vertical portion of the support arm (60) into the hollow vertical support pipe (62) and locking it in place with a set-screw (51) threaded into a collar (52), tripod leg clamp, or similar element. The vertical shaft of the support arm (60) is attached to the tray (8) with a swivel (61), so that the tray may be swiveled in a horizontal plane to aim the projector as desired. The vertical support pipe (62) forms part of a vacuum base (64) of conventional design. The vacuum base (64) can be moved into a desired position on the desktop, and then a vacuum lever (63) is moved to create a partial vacuum between the vacuum base gasket (65) and the desktop, holding it firmly in place. Vacuum bases of this kind are often used for table-top mounting of vises, lamps, camera supports or circuit-board clamps, but have not previously been used to mount projector supports in the novel desktop monitor of the invention.

71. FIGS. 7 and 8 illustrate the space-saving advantages of the invention, whereby a user practicing the method of the invention confined in a small workspace may be provided with a larger display, and be spaced further from the display, than if using a conventional CRT computer monitor, and may additionally benefit from viewing a reflected rather than a direct image. FIG. 7 shows a plan view of a typical cubicle arrangement with a CRT, and FIG. 8 a comparable view using the projector display of the invention. Thus, in FIG. 7, the cubicle is defined by a wall 72 spaced by distance D from a back wall or other furniture 76. Into this space users typically desire to fit the largest possible desk 70 (since desktop space is at a premium) allowing room for a chair 74. As noted, a typical computer monitor is roughly cubical, so that a monitor 78 having a diagonal screen measurement of M will be approximately M deep; stated differently, the display screen of a conventional monitors 78 must be spaced a considerable distance (comparable to the diagonal measurement of the screen by which such monitors are usually selected) from the back wall 72, which in turn limits the viewing distance between the user (indicated at 80) and the screen of monitor 78 to a short distance d₁. It is likely that the shortness of this distance contributes to eyestrain; certainly it is undisputed that many people find that as their eyes age, it becomes more difficult to focus at short distances. Moreover, as noted, in this arrangement the user experiences direct transmission of the light from the screen to the eye, which, according to the inventor's Computer Eyestrain Theory (which, as also noted, does not limit the invention, but merely explicates the utility thereof) contributes to eyestrain and, of course, the monitor 78 takes up a substantial amount of valuable desktop real estate.

72. FIG. 8 shows the comparable arrangement according to the invention. The same cubicle is provided, so that desk 70 and chair 74 have to be fitted into the same space D. However, instead of monitor 78, the user is provided with a projector 82 mounted on a stand 86 (in this case, having a U-shaped clamping arrangement, for stability while consuming a minimal amount of desktop real estate), and projecting a display image onto a screen 84. As screen 84 is essentially flat (and may even be wall 72, if suitably smooth and light-colored) it consumes no space. Hence the viewing distance d₂ between the screen 84 and viewer 80 is at least greater than d₁ by M, so that the viewer's eyes are focussed at a longer distance d₂ than previously, reducing eyestrain. As illustrated in FIG. 8, an image of width W can thus be provided in a given space that is much larger than M, the largest image possible using a standard monitor. That is, providing an image of width W in the space illustrated using a conventional monitor would be out of the question, as the monitor required would be so large that the viewer's eyes would be but a few inches from the screen, making it impossible to see the entire image. Stated differently, according to the invention, an image of greater size W is provided at a greater distance from the eyes, reducing the effective width of the image as compared to the prior art, and similarly reducing the amount of head-swiveling and refocusing necessary to view the entire image, and further alleviating viewing fatigue.

73. Moreover, according to the invention d ₃, the distance between the projector to the screen, is equal to the sum of d_{L}, the depth of the desk, and d_{A}, the effective length of the support arm. That is, provision of the support arm structure according to the invention allows the projector to be spaced further from the screen than would be possible if the projector were obliged to be supported by the desk surface alone. This allows focusing of the projected image on the screen in relatively small spaces, as illustrated. Still further, because the overall distance from the light source, i.e., projector 82, to the viewer includes not only d₂ but also d ₃, to the extent eyestrain may be a function of the distance between source and eye, it will be reduced according to the invention for this reason. Finally, in accordance with the inventor's Computer Eyestrain Theory, the light undergoes reflection at screen 84, further reducing eyestrain.

74. Thus, according to the method of the invention, in order to maximize the width W of the image viewed by a user constrained to a workplace having maximum depth D, one arranges a projector 82 to project the image generally parallel to dimension D, provides a screen or other suitable reflecting surface substantially perpendicular to dimension D, and then views the image at a distance d₂ which is essentially D less the space required for the user, and (typically) a suitable chair. One can then control the projector to provide an image of width W, measured perpendicular to D, that is significantly larger than the image available on a computer monitor fitting into the same workspace and viewed at a significantly greater distance, both reducing eyestrain. For example, if the depth d_{L} of desk 70 is 30 inches according to the invention an image of width W equal to 30 inches is entirely feasible, while even a 15-inch monitor would consume an undesirably large proportion of such a desk. As noted, the invention also provides a reflection in the path between the user's eyes and the projector, which itself serves to further reduce eyestrain according to the inventor's Computer Eyestrain Theory.

75. It will therefore be appreciated that according to the invention, eyestrain occasioned by use of computer monitors is reduced for one or more of several related reasons: (1) By increasing the distance from the viewing screen to the eye, the viewer sees a large image at a greater distance than if viewing the same size image on a monitor fitting into the same space. This increases the focussing distance, providing a first beneficial effect. Further, increasing the spacing between the viewer and the screen reduces the effective width of an image of given size, reducing the amount of head-swiveling and refocusing necessary to view the entire image. (2) The distance from the light source to the eye is also increased, possibly further reducing eyestrain. (3) The image also undergoes reflection before it is viewed, reducing eyestrain according to the inventor's Computer Eyestrain Theory (which again is not intended to limit the invention). Furthermore, of course, in the preferred embodiment in which the projector is mounted on a stand secured to the user's desk by a clamp or the like (or can even be supported entirely apart from the desk) the invention has the advantage of consuming less of the desktop space, and permits focusing of the image in cases where the desktop is insufficiently wide to so so if the projector were supported thereby.

76. Accordingly, it is to be understood that the embodiments of the invention herein described are merely illustrative of the application of the principles of the invention. Reference herein to details of the illustrated embodiments are not intended to limit the scope of the claims, which themselves recite those features regarded as essential to the invention.

What is claimed is:

1. A method of employing a display system, for use within a workspace defined by a wall or other physical element to be limited in extent to a dimension D of limited depth, said method providing a visible image responsive to a video signal provided by a computer, wherein a transverse dimension W of said image is relatively large compared to the dimension D of the space within which said display system is employed, said dimension W being measured in a direction generally perpendicular to said dimension D, said method comprising the steps of: providing a projector adapted to be connected to said computer for projecting an image responsive to said video signal, arranging said projector so as to project the image in a direction generally parallel to said dimension D, providing a screen for reflecting said image toward a viewer, arranging said screen so that its reflecting surface is generally perpendicular to the direction of projection of said image, and so that said reflecting surface is disposed in juxtaposition to said wall or other physical element defining said dimension D, and projecting said image toward said screen, whereby the width W of said image is maximized for a given depth D of the workspace.

2. The method of claim 1, comprising the further step of supporting said projector on an adjustable support mechanism secured to a desk or like surface disposed in said workspace, said support mechanism covering less of the surface of said desk than would said projector if disposed on said surface, and permitting said projector to be spaced further from said screen than if said projector were disposed on said surface.
